(19) United States
(12) Patent Application Publication
(10) Pub. No.: US 2026/0133290 A1
(43) Pub. Date: May 14, 2026

(54) OPTICAL RANGING MODULE

(71) Applicant: Newmax Technology Co., Ltd., Taichung City (TW)

(72) Inventors: Yung-Fu LIANG, Taichung City (TW); Chiung-Hung CHEN, Taichung City (TW)

(21) Appl. No.: 19/094,746

(22) Filed: Mar. 28, 2025

(30) Foreign Application Priority Data
Nov. 8, 2024 (TW) 113142980

(51) Int. Cl. G01S 7/481; G01S 17/08

(52) U.S. Cl. CPC G01S 7/4813; G01S 7/4814; G01S 7/4816; G01S 17/08

(57) ABSTRACT

An optical ranging module includes an optical transmitting unit, an optical receiving unit, a supporting cap, a base, a conductive film and an anti-reflective film. The supporting cap includes a top portion and an annular sidewall connected to the top portion. The top has an object-side surface, the annular sidewall has an outer surface, and the optical transmitting unit and the optical receiving unit is respectively disposed in two openings of the top portion. The base is disposed on one side of the supporting cap towards the element side, and first and second accommodation spaces are defined between the base and the supporting cap. The conductive film is disposed on the object-side surface of the top portion and the outer surface of the annular sidewall of the supporting cap. The anti-reflective film is configured to cover the conductive film of the top portion of the supporting cap.

This application claims the benefit of Taiwan Patent Application No. 113142980, filed on November 8, 2024, which is hereby incorporated by reference for all purposes as if fully set forth herein.

### BACKGROUND

### Technical Field

The present disclosure relates to an optical ranging module, and in particular to an optical ranging module including an anti-reflective film.

### Related Art

Time of Flight (ToF) is a method that uses a transmitter to continuously send light to a target object, and then uses an optical sensor to receive the light returned from the target object, so as to obtain the target distance by detecting the flight time (round-trip) of the light. Currently, three-dimensional cameras of electronic devices mainly use optical ranging modules having the ToF, which include an optical transmitting unit, an optical receiving unit and a supporting cap.

Generally speaking, consumer electronic products with communication functions such as smartphones, TVs, digital cameras with Wi-Fi or Bluetooth comply with various certification standards by using anti-electromagnetic interference shielding on their casings. Furthermore, in order to reduce the risk of the erroneous operation caused by electromagnetic interference between different chips or electronic components, electronic components will also be shielded. For optical ranging modules with ToF, a metal film (such as anti-electromagnetic interference coating) is currently formed on the outer surface of the supporting cap to reduce the electromagnetic interference caused by electronic components to the outside world.

However, metal films usually have high optical reflectivity, which can easily produce stray light on electronic devices, causing the measurement interference of the optical ranging module.

Thus, an optical ranging module needs to be provided for resolving previous problems.

### SUMMARY

An objective of the present disclosure is to provide an optical ranging module including an anti-reflective film, the anti-reflective film is configured to cover the conductive film on a top portion of a supporting cap; and, the anti-reflective film is a low- chroma and low-luminance material, which reduces the optical reflectivity of the top portion of the supporting cap, thereby improving the measurement accuracy of the optical ranging module.

To achieve the above objective, the present disclosure provides an optical ranging module, defining an object side and an element side opposite to the object side, the optical ranging module comprising: an optical transmitting unit comprising, in order from the object side to the element side: a first optical lens assembly and a light source; an optical receiving unit comprising, in order from the object side to the element side: a second optical lens assembly and an optical sensor; a supporting cap comprising a top portion and an annular sidewall connected to the top portion, wherein the top portion has an object-side surface, the annular sidewall has an outer surface, the top portion includes two openings penetrating from the object side to the element side, and the first optical lens assembly of the optical transmitting unit and the second optical lens assembly of the optical receiving unit are respectively disposed in the two openings; a base disposed on one side of the supporting cap towards the element side, wherein a first accommodation space and a second accommodation space are defined between the base and the supporting cap, the first accommodation space is used to accommodate the first optical lens assembly and the light source of the optical transmitting unit, and the second accommodation space is used to accommodate the second optical lens assembly and the optical sensor of the optical receiving unit; a conductive film disposed on the object-side surface of the top portion and the outer surface of the annular sidewall of the supporting cap; and an anti-reflective film configured to cover the conductive film on the top portion of the supporting cap.

According to the optical ranging module of the present disclosure, the anti-reflection film can reduce the optical reflectivity of the conductive film on the top portion of the supporting cap, thereby reducing the formation of stray light, thereby improving the measurement accuracy of the optical ranging module. Furthermore, the anti-reflective film has low luminance and chroma, and its blackening effect makes the end product (e.g., electronic device) have a more consistent appearance.

### BRIEF DESCRIPTION OF THE DRAWINGS

FIG. 1 is a schematic sectional view of an optical ranging module according to the first embodiment of the present disclosure, showing that a conductive film is disposed on the top portion and the annular sidewall of the supporting cap, and an anti-reflection film is configured to cover the conductive film on the top portion of the supporting cap.

FIG. 1a is a schematic perspective view of an optical transmitting unit, an optical receiving unit and a supporting cap according to the first embodiment of the present disclosure.

FIG. 2 is a schematic sectional view of an optical ranging module according to the second embodiment of the present disclosure.

FIG. 2a is a schematic perspective view of an optical transmitting unit, an optical receiving unit and a supporting cap according to the first embodiment of the present disclosure.

FIG. 3 is a reflectance spectrum chart of various materials on the top portion of the supporting cap of the present disclosure at different light wavelengths, showing that the material properties of the supporting cap, the conductive film and the anti-reflection film.

### DETAILED DESCRIPTION

To make the foregoing objectives, characteristics and features of the present disclosure more comprehensible, preferred embodiments of the present disclosure are described in detail below with reference to the accompanying drawings.

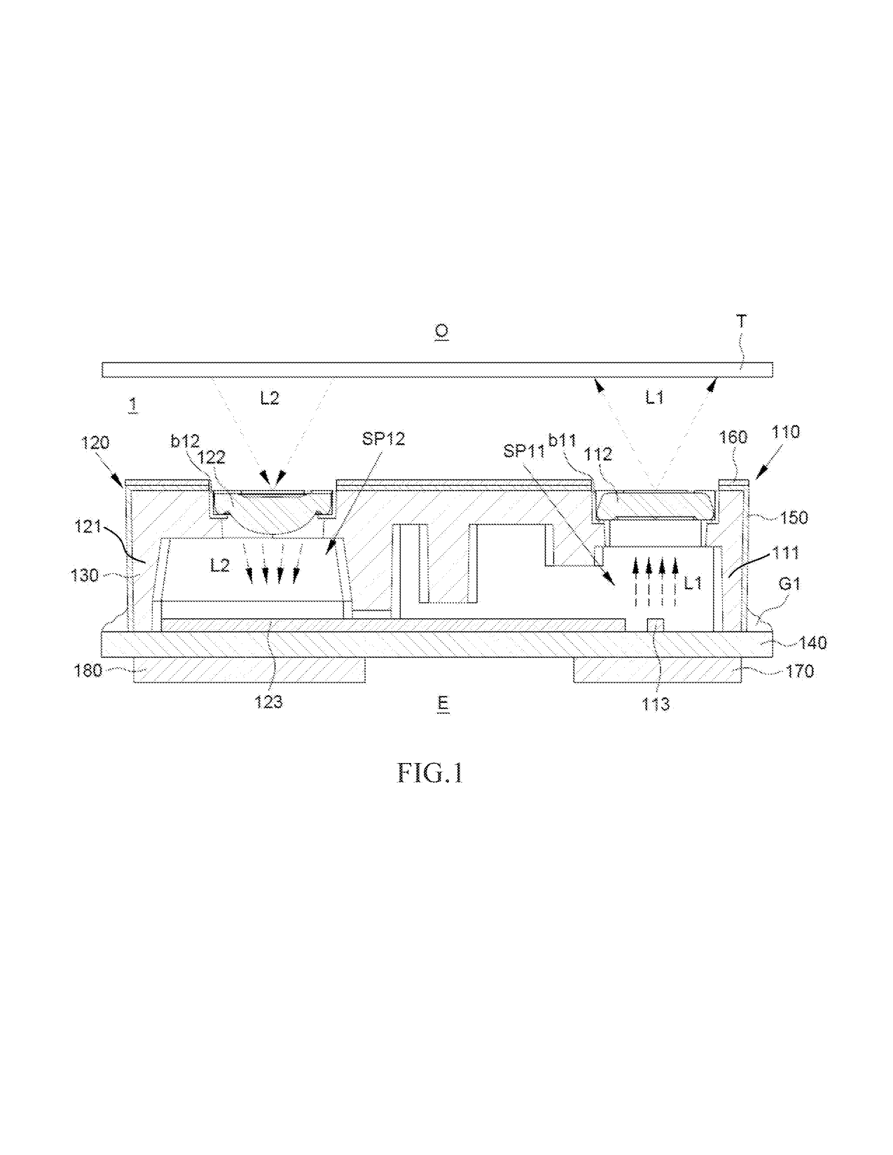

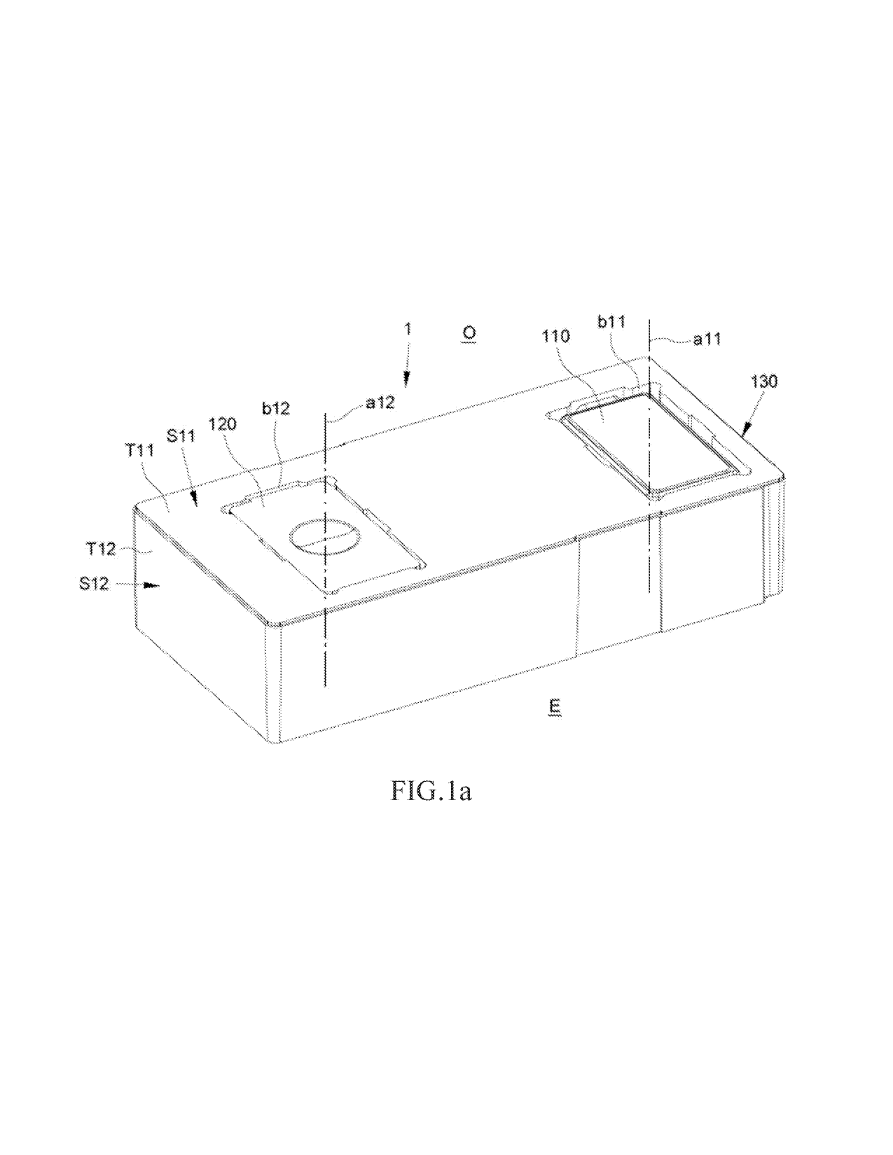

FIG. 1 is a schematic sectional view of an optical ranging module according to the first embodiment of the present disclosure, showing that a conductive film is disposed on the top portion and the annular sidewall of the supporting cap, and an anti-reflection film is configured to cover the conductive film on the top portion of the supporting cap. FIG. 1a is a schematic perspective view of an optical transmitting unit, an optical receiving unit and a supporting cap according to the first embodiment of the present disclosure. Referring to FIG. 1 and FIG. 1a, the optical ranging module 1 defines an object side O and an element side E opposite to the object side O, and includes: an optical transmitting unit 110, an optical receiving unit 120, a supporting cap 130, a base 140, a conductive film 150 and an anti-reflective film 160.

The optical transmitting unit 110 has a first central axis a11 and a first lens barrel 111 surrounding the first central axis a11. The optical transmitting unit 110 includes, in order from the object side O to the element side E: a first optical lens assembly 112 and a light source 113 which are sequentially disposed in the first lens barrel 111. The first optical lens assembly 112 includes at least one optical lens. The light source 113 is an infrared light source that provides an infrared light toward a target object located on the object side O. The light source 113 can be a Vertical Cavity Surface Emitting Laser (VCSEL), or an Edge Emitting Laser (EEL), but is not limited thereto.

The optical receiving unit 120 has a second central axis a12 and a second lens barrel 121 surrounding the second central axis a12. The optical receiving unit 120 includes, in order from the object side O to the element side E: a second optical lens assembly 122 and an optical sensor 123 which are sequentially disposed in the second lens barrel 121. The second optical lens assembly 122 includes at least one optical lens. The optical sensor 123 can be a photosensitive element for receiving the light that passes through the second optical lens assembly 122. The photosensitive element can be a Complementary Metal Oxide Semiconductor (CMOS) or a charge coupled device (CCD), but is not limited thereto.

The supporting cap 130 can be a shell, and includes a top portion T11 and an annular sidewall T12 connected to the top portion T11. The top portion T11 has an object-side surface S11 that is a plane. The annular sidewall T12 extends from the top portion T11 toward the element side E and has an outer surface S12. The supporting cap 130 includes a first opening b11 and a second opening b12 that can penetrate from the object side O to the element side E. The first optical lens assembly 112 of the optical transmitting unit 110 is disposed in the first opening b11, and an object-side surface of the first optical lens assembly 112 of the optical transmitting unit 110 and the first opening b11 both face the object side O. The light L1 of the light source 113 passes through the first optical lens assembly 112 and then travels to the object side O through the first opening b11. The second optical lens assembly 122 of the optical receiving unit 120 is disposed in the second opening b12, and the object-side surface of the second optical lens assembly 122 of the optical receiving unit 120 and the second opening b12 both face the object side O. The optical sensor 123 receives the light L2 from the object side O and passes through the second optical lens assembly 122. The supporting cap 130 can be made of black plastic material. The supporting cap 130 is usually made of black plastic material by using an injection molding process, but is not limited thereto.

The base 140 is disposed on one side of the supporting cap 130 towards the element side E, wherein a first accommodation space SP11 and a second accommodation space SP12 are defined between the base 140 and the supporting cap 130. The first accommodation space SP11 is used to accommodate the first optical lens assembly 112 and the light source 113 of the optical transmitting unit 110, and the second accommodation space SP12 is used to accommodate the second optical lens assembly 122 and the optical sensor 123 of the optical receiving unit 120.

The conductive film 150 is disposed on all or part of the object-side surface S11 of the top portion T11 of the supporting cap 130, and the conductive film 150 is disposed on all or part of the outer surface S12 of the annular sidewall T12.

The anti-reflective film 160 is configured to cover the conductive film 150 on the top portion T11 of the supporting cap 130. The anti-reflective film 160 has a thickness between 20 μm and 2000 μm. The object-side surface S11 of the anti-reflective film 160 has a luminance of less than 5 cd/m².

In the optical ranging module 1, the optical transmitting unit 110 further includes a driving element 170 electrically connected to the light source 113, and the optical receiving unit 120 further includes a control element 180 electrically connected to the optical sensor 123, The base 140 includes a conductive wire (not shown) electrically connected to the driving element 170 or the control element 180. The optical ranging module 1 includes a conductive adhesive G1, which is disposed at a connection point between the conductive film 150 and the base 140 for electrically connecting to the conductive film 150 and the conductive wire.

In detail, in the above-mentioned optical ranging module 1, the conductive film 150 provided on the supporting cap 130 is electrically connected to the ground terminal in the conductive wire of the base 140 through the conductive adhesive G1, so that the conductive film 150 serves as an EMI coating to shield the electromagnetic interference outside the electronic device. The conductive film 150 can be formed by manufacturing processes such as electroplating, evaporation, vacuum sputtering or optical sputtering. When the conductive film 150 has a larger thickness range between 1000 μm and 20000 μm, the conductive film 150 can have lower electrical impedance. Preferably, the conductive film 150 can be made of a material having low electrical resistance, such as metal material such as one of gold, silver, copper, nickel, chromium and stainless steel.

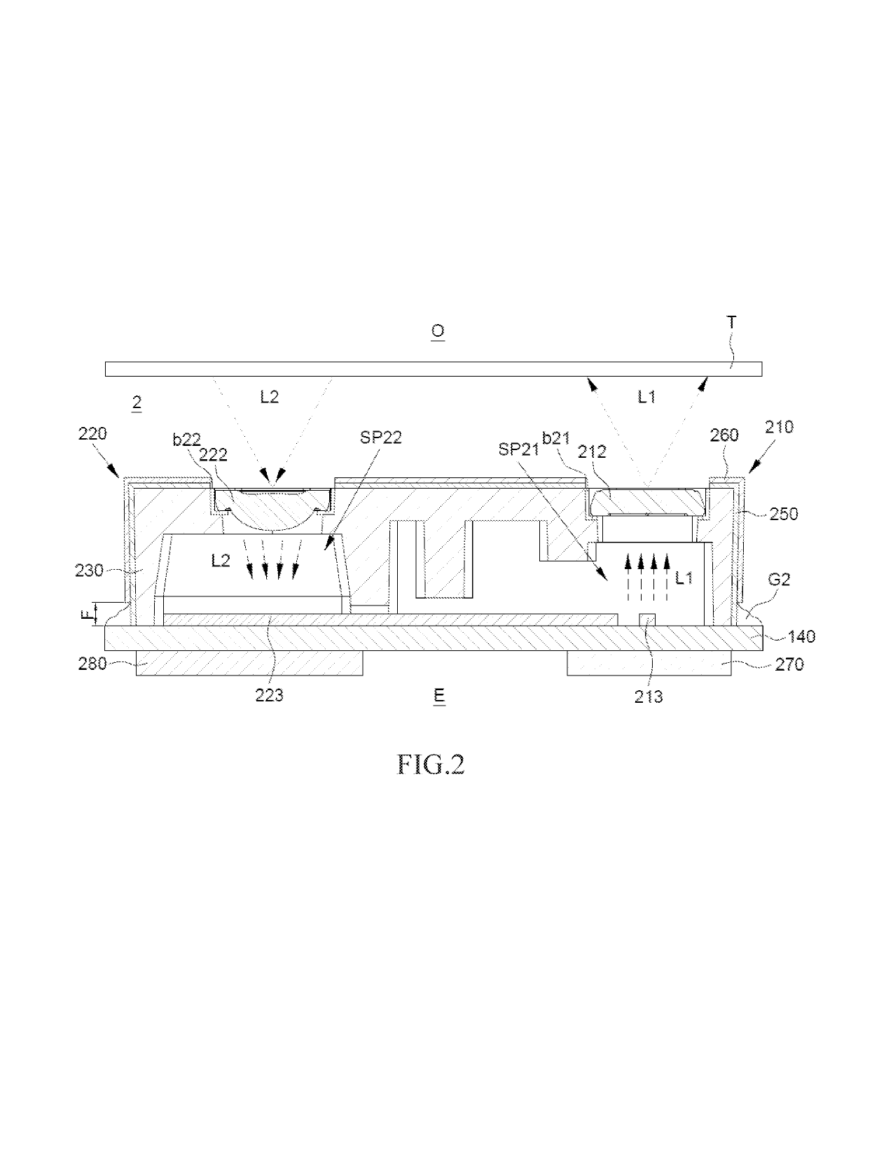

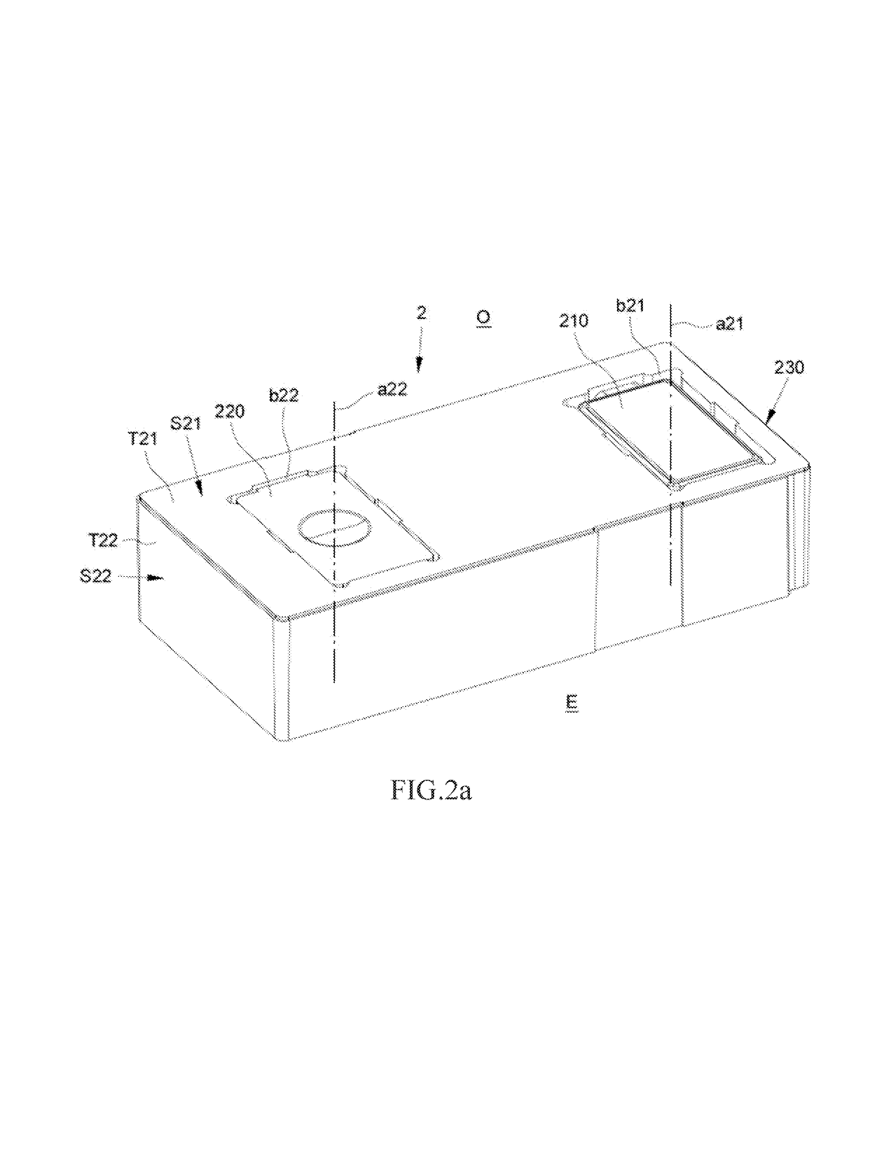

FIG. 2 is a schematic sectional view of an optical ranging module according to the second embodiment of the present disclosure. FIG. 2a is a schematic perspective view of an optical transmitting unit, an optical receiving unit and a supporting cap according to the first embodiment of the present disclosure. Referring to FIG. 2 and FIG. 2a, the optical ranging module of the second embodiment is substantially similar to the optical ranging module of the first embodiment, and similar components are labeled with similar numbers. The difference between the optical ranging module 2 of the second and the optical ranging module 1 of the first embodiments is that: in the second embodiment, the anti-reflective film 260 of the optical ranging module 2 of the present disclosure is configured to cover the conductive film 250 on the top portion T21 of the supporting cap 230, and further extends to cover the conductive film 250 on the annular sidewall T22. The anti-reflective film 260 only exposes a region F so that the conductive film 250 is in contact with the conductive adhesive G2.

Please refer to FIG. 1 and FIG. 2 again. In the above-mentioned optical ranging module, the conductive film is disposed on the top portion of the supporting cap and the annular sidewall of the supporting cap. The anti-reflective film can only cover the conductive film on the top portion of the supporting cap (as described in the first embodiment), and the anti-reflective film can further extend to cover the conductive film on the annular sidewall (as described in the second embodiment). The anti-reflective films 160, 260 can be titanium trioxide or silicon dioxide, served as a low-chroma material and an antioxidant material. Referring to FIG. 1 again, when the anti-reflective film 160 only covers the conductive film 150 on the top portion T11 of the supporting cap 130, the anti-reflective film 160 has a luminance (L*) of less than 5 cd/m² and an optical reflectivity of less than 5% at an optical wavelength between 380nm and 980nm. Therefore, the formation of stray light can be reduced, thereby improving the ranging accuracy of the optical ranging module 1. Referring to FIG. 2 again, when the anti-reflective film 260 extends to cover the conductive film 250 on the annular sidewall T22, and only a region F is exposed so that the conductive film 250 is in contact with the conductive adhesive G2, the anti-reflective film 260 can be used as an anti-oxidation film to reduce the oxidation of the conductive film 250. In addition, the exposed region F of the anti-reflective film 260 has a luminance (L*) range between 15 cd/m² and 30 cd/m², and the unexposed region of the anti-reflective film 260 has a luminance (L*) of Less than 5 cd/m².

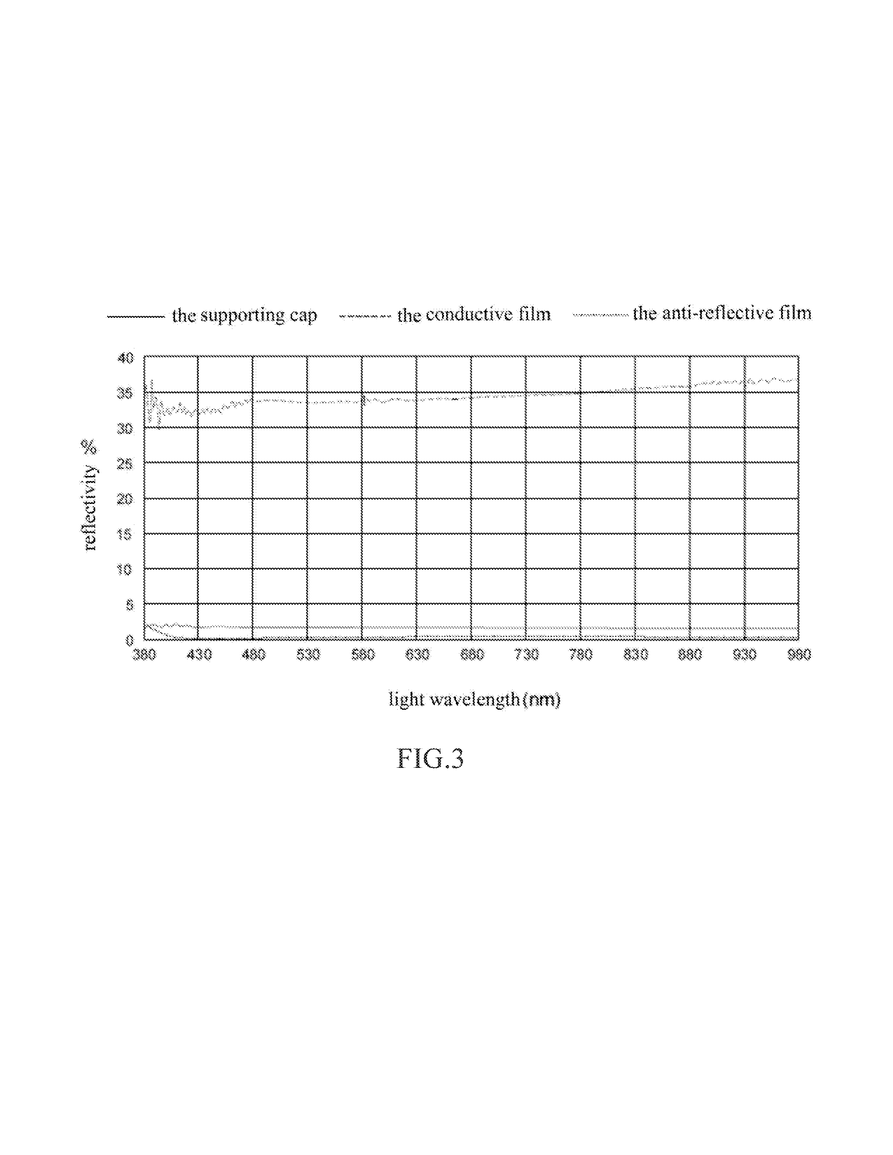

FIG. 3 is a reflectance spectrum chart of various materials on the top portion of the supporting cap of the present disclosure at different light wavelengths, showing that the material properties of the supporting cap, conductive film and anti-reflection film. In the above-mentioned optical ranging module, when only the conductive film in the prior art is disposed on the supporting cap, the optical reflectivity at the light wavelength range between 380nm and 980nm is between 28% and 37%, and stray light is easily formed; and after the conductive film and the anti-reflection film of the present disclosure are disposed on the supporting cap, the optical reflectivity of less than 5% at the light wavelength range between 380nm and 980nm can arrive the better measurement accuracy of the optical ranging module.

The optical ranging module 1 of the present disclosure can be used in optical systems, and can be used in various aspects such as facial recognition of 3D (three-dimensional) image capture, automatic focusing or depth sensing shooting function of consumer electronic products, the tracking user movements of virtual reality (VR) and augmented reality (AR), autonomous driving and driver assistance systems (ADAS) or gesture control in the automotive industry, positioning in robots and industrial automation, navigation on object recognition and real-time distance measurement by drone.

In view of the above, the foregoing descriptions are merely preferred embodiments of technical means adopted by the present disclosure to solve the problem, but are not intended to limit the scope of the embodiments of the present disclosure. That is, all equivalent changes and modifications made in accordance with the scope of the patent application of the present disclosure or made in accordance with the scope of the patent of the present disclosure fall within the scope of the patent of the present disclosure.

What is claimed is:

1. An optical ranging module, defining an object side and an element side opposite to the object side, the optical ranging module comprising:
an optical transmitting unit comprising, in order from the object side to the element side: a first optical lens assembly and a light source;
an optical receiving unit comprising, in order from the object side to the element side: a second optical lens assembly and an optical sensor;
a supporting cap comprising a top portion and an annular sidewall connected to the top portion, wherein the top portion has an object-side surface, the annular sidewall has an outer surface, the top portion includes two openings penetrating from the object side to the element side, and the first optical lens assembly of the optical transmitting unit and the second optical lens assembly of the optical receiving unit are respectively disposed in the two openings;
a base disposed on one side of the supporting cap towards the element side, wherein a first accommodation space and a second accommodation space are defined between the base and the supporting cap, the first accommodation space is used to accommodate the first optical lens assembly and the light source of the optical transmitting unit, and the second accommodation space is used to accommodate the second optical lens assembly and the optical sensor of the optical receiving unit;
a conductive film disposed on the object-side surface of the top portion and the outer surface of the annular sidewall of the supporting cap; and
an anti-reflective film configured to cover the conductive film on the top portion of the supporting cap.

2. The optical ranging module according to claim 1, further comprises a conductive adhesive, which is disposed at a connection point between the conductive film and the base and is electrically connected to the conductive film.

3. The optical ranging module according to claim 1, wherein the conductive film has a thickness range between 1000 μm and 20000 μm.

4. The optical ranging module according to claim 1, wherein the material of the conductive film is selected from one of gold, silver, copper, nickel, chromium and stainless steel.

5. The optical ranging module according to claim 1, wherein the anti-reflective film is a low-chroma material selected from one of titanium trioxide and silicon dioxide.

6. The optical ranging module according to claim 1, wherein the anti-reflective film has a thickness range between 20 μm and 2000 μm.

7. The optical ranging module according to claim 1, wherein the object-side surface of the anti-reflective film has a luminance of less than 5 cd/m².

8. The optical ranging module according to claim 1, wherein the conductive film on the annular sidewall has a luminance range between 15 cd/m² and 30 cd/m².

9. The optical ranging module according to claim 1, wherein the anti-reflective film has an optical reflectivity of less than 5% at light wavelength range between 380 nm and 980 nm.

10. The optical ranging module according to claim 2, wherein the anti-reflective film further extends to cover the conductive film on the annular sidewall, and only exposes a region for connecting the conductive film to the conductive adhesive.
